(19) United States
(12) Patent Application Publication
(10) Pub. No.: US 2023/0334434 A1
(43) Pub. Date: Oct. 19, 2023

(54) HORTICULTURAL LIGHTING

(71) Applicant: SIGNIFY HOLDING B.V., Eindhoven (NL)

(72) Inventors: MASSIMO TUMOLO, UTRECHT (NL); MARCELLINUS PETRUS CAROLUS MICHAEL KRIJN, EINDHOVEN (NL); YANNICK MARTINUS DENISE MOREL, EINDHOVEN (NL); SRI ANDARI HUSEN, EINDHOVEN (NL)

(21) Appl. No.: 18/026,952

(22) PCT Filed: Sep. 23, 2021
(86) PCT No.: PCT/EP2021/076197

§ 371 Date: Mar. 17, 2023

(30) Foreign Application Priority Data
Sep. 24, 2020 (EP) 20198021.6

(51) Int. Cl. G06Q 10/20; G06Q 10/0637; G06Q 50/02

(52) U.S. Cl. CPC G06Q 10/20; G06Q 10/06375; G06Q 50/02

(57) ABSTRACT

Operation of one or more luminaires (120) of a horticulture lighting system is monitored, the horticultural lighting system providing lighting for plants (110) within an environment (100). A possible maintenance action to be performed on the lighting system is identified based on the monitoring. An effect on yield resulting from the possible maintenance action being enacted is determined and an output indicative of that effect is generated.

### TECHNICAL FIELD

The present disclosure relates to a method and controller for monitoring a horticultural lighting system.

### BACKGROUND

The term “horticulture” refers to the agriculture of plants such as flowers, fruits, vegetables, etc. into a crop. The crop may be harvested for the purposes of food, decoration, materials, etc. The amount of crop grown per unit area of land (e.g. in kilograms per hectare) is often referred to as the “crop yield” or simply “yield”. In a given growing setup, the area of land or the like used to grow a particular crop may be fixed. For example, a greenhouse of a certain size may be used to grow a crop. Hence, the term “yield” can also be used to refer to the amount of crop itself (e.g. in kilograms).

Various factors affect the yield. It is generally known how to estimate the yield of a crop for a known set of growing parameters (e.g. light, temperature, carbon dioxide levels, etc.).

### SUMMARY

The invention is defined by the claims appended at the end of the present disclosure.

According to a first aspect disclosed herein, there is provided a method of monitoring a horticulture lighting system that provides lighting for plants within an environment, the method comprising: monitoring operation of one or more luminaires of the horticulture lighting system; identifying a possible maintenance action to be performed on the lighting system based on the monitoring; determining an effect on yield resulting from the possible maintenance action being enacted; and generating an output indicative of said effect. The environment may be a horticulture facility such as a greenhouse, a garden, a vertical farm, etc. The method preferably is a computer-implemented method.

In an example, determining the effect on yield comprises estimating a first yield value based on the possible maintenance action not being enacted, estimating a second yield value based on the possible maintenance action being enacted, and determining the effect on yield as the difference between the second yield value and the first yield value.

In an example, the method comprises receiving temperature data indicative of a temperature within the environment and wherein the effect on yield is determined based at least in part on the temperature data.

The temperature data may be comprised in weather data. The temperature data may for example be measured by one or more sensors located within the environment and/or obtained over the Internet from a weather forecasting organisation or the like.

In an example, the method comprises receiving ambient light data indicative of ambient light within the environment, and the effect on yield is determined based at least in part on the ambient light data.

The ambient light data may be comprised in weather data. The ambient light data may for example be measured by one or more sensors located within the environment and/or obtained over the Internet from a weather forecasting organisation or the like.

In an example, the method comprises receiving carbon dioxide data indicative of a carbon dioxide level within the environment, and the effect on yield is determined based at least in part on the carbon dioxide data.

The carbon dioxide data may for example be measured by one or more sensors located within the environment.

In an example, the method comprises receiving pest data indicative of pests within the environment, and the effect on yield is determined based at least in part on the pest data.

The pest data may for example be received from a pest detection system located within the environment. Alternatively or additionally, the pest data may be provided by a user (e.g. a grower or manager of the environment).

In an example, the method comprises receiving plant age data indicative of an age of the plants, and the effect on yield is determined based at least in part on the plant age data.

The plant age data may be accessed from a database storing plant age data. The plant age data may be input by a user or derived from input from a user. The plant age may be deduced from sensors monitoring the growth of plants, such as cameras, or from a horticulture management system monitoring the horticulture production process.

In an example of the method, the monitoring comprises monitoring prior usage of the one or more luminaires to identify an expected time of failure or identify performance deterioration of a luminaire, and the possible maintenance action is replacement of said luminaire. Performance deterioration may refer to reduced light output versus electric input due to, for example, aging of the light source, accumulation of dust on optics, etc.

Aspects of prior usage which may be monitored to identify an expected time of failure or performance deterioration of a luminaire include, e.g., historical power levels, time on, output level etc. Expected failure of a luminaire may be identified by additionally taking into account environmental data (e.g. temperature, rain, humidity, etc.) in which the luminaire operates or operated.

In an example, the possible maintenance action is replacement, fixing or upgrading a luminaire. For example, the possible maintenance action may include replacement or fixing of a failed or degraded luminaire, replacement of a near end-of-life luminaire, or upgrade of an old luminaire. It is appreciated that a luminaire does not need to actually fail before “maintenance” can be carried out. For example, deteriorated performance of a luminaire, as referred to above, can enact a maintenance action in terms of replacing such luminaire, upgrading such luminaire (e.g., to improve performance) or fixing such luminaire (e.g., by cleaning the optics). In this regard, the term “preventive maintenance” may be used generally to refer to taking any action on the lighting system to change its operation or improve its reliability or lifetime. For example, if one luminaire is broken and needs replacing or fixing, and a neighbour luminaire is still functioning but nearing the end of its operational life, both luminaires may be replaced at the same time to save on (future) cost. Each maintenance action can have the possibility of damaging the plants and affecting yield (in a negative way). Performing preventative maintenance in this manner can reduce the number of maintenance actions and therefore avoid affecting the yield.

In an example, the method comprises deciding on enacting the possible maintenance action based on the generated output. For example, based on the determined effect on yield resulting from the possible maintenance action being enacted, the method may decide whether or not to enact the maintenance action and when to enact the maintenance action. This decision may be based on thresholds for minimum and/or maximum effects on yield. For example, a minimum effect on yield, e.g., a minimum yield loss in terms of kilograms of produce or loss or revenues, may be required to decide to enact a maintenance action. As another example, if the effect on yield exceeds a maximum effect, e.g., a maximum allowable yield loss in terms of kilograms of produce or loss or revenues, then the method may decide to immediate enact the maintenance action. And further, if the effect is larger than a minimum effect but smaller than a maximum effect, then the method may decide to postpone the maintenance action. Alternatively or additionally, the decision may be based on feedback from a user or operator of the horticulture lighting system or a manager of the horticulture facility on the generated output indicative of the effect of the possible maintenance action of the yield. The output may for example be presented on a user interface of the horticulture lighting system and the user may provide feedback via the user interface to either proceed, postpone. decline or adapt the possible maintenance action, for example by combining maintenance actions.

In a further example, the method comprises adapting a light setting of the horticulture lighting system based on a decision on enacting the possible maintenance action. For example, depending on whether the decision is the immediately enact, postpone or not enact the maintenance action, the lighting setting of the horticulture lighting system, e.g., in terms of intensity and spectrum of light emitted by the one or more luminaires, e.g., the luminaire(s) in close proximity to the failed or deteriorated luminaire, may be adapted to compensate for the failed or deteriorated luminaire, thereby reducing the effect on yield of the failed or deteriorated luminaire.

In an example, the method comprises: receiving crop price data; and converting the determined effect on yield into a gross monetary value based on the crop price data; wherein said output is an indication of the gross monetary value.

In an example, the method comprises: identifying one or more costs associated with the possible maintenance action being performed; and determining a net monetary value based on the gross monetary value and the one or more costs associated with the possible maintenance action being performed; wherein said output is an indication of the net monetary value.

In an example, the one or more costs comprise a cost of performing the possible maintenance action.

In an example, the one or more costs comprise an additional energy cost, incurred by performance of the possible maintenance action, for producing the yield. For example, replacing a failed luminaire (which does not consume energy anymore) with a new luminaire will mean that the amount of energy required to run the lighting system will increase.

The “cost” may be negative (that is, the method may comprise identifying one or more benefits or a reductions in energy cost associated with the possible maintenance action being performed). For example, a new luminaire may require less power than an old luminaire for the same light output. The reduction in energy cost to produce the yield, i.e. the decrease in running cost, may be taken into account as a “negative energy cost incurred by performance of the possible maintenance action”.

In examples, the methods described herein are hosting a horticulture management system for implementing one or more of the method features described above by a supplier of the horticulture lighting system, wherein the hosting is at least partially off-site from the environment; and

providing a wired or wireless communication between the off-site part of the horticulture management system and the horticulture lighting system on-site in the environment, for monitoring operation of the one or more luminaires of the horticulture lighting system.

According to a second aspect disclosed herein, there is provided a controller for monitoring a horticulture lighting system that provides lighting for plants within an environment, the controller being configured to, in operation: monitor operation of one or more luminaires of the horticulture lighting system; identify a possible maintenance action to be performed on the lighting system based on the monitoring; determine an effect on yield resulting from the possible maintenance action being enacted; and generate an output indicative of said effect.

According to a third aspect disclosed herein, there is provided a computer program comprising instructions such that when the computer program is executed on a computing device, the computing device is arranged to monitor a horticulture lighting system that provides lighting for plants within an environment by: monitoring operation of one or more luminaires of the horticulture lighting system; identifying a possible maintenance action to be performed on the lighting system based on the monitoring; determining an effect on yield resulting from the possible maintenance action being enacted; and generating an output indicative of said effect.

There may be provided a non-transitory computer-readable storage medium storing a computer program as described above.

In summary, disclosed are method/systems/programs to monitor and collect historical information of the operation of the luminaires; assess, based on historical and actual information of the operation of the luminaires, if there are luminaires that are close to failing (end-of-life), have already failed or show deteriorated operation and lead to sub-optimal operation of the horticulture lighting system; identify a possible maintenance action to resolve the sub-optimal operation of the horticulture lighting system; determine the differential effect on yield of either executing or not the suggested maintenance action; and generate an output indicative of such differential effect allowing a grower or user of the horticulture lighting system or a horticulture facility monitoring system to decide on whether or not to proceed with executing the maintenance action, postpone the maintenance action, decline the maintenance action or adapt/combine the maintenance action with other actions.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of an environment for growing one or more plants;

FIG. 2 shows schematically an example of a method performed by a controller according to the present disclosure; and

FIG. 3 shows schematically an example of a controller according to the present disclosure.

### DETAILED DESCRIPTION

There is a strong relation between the amount of light provided to plants and growth/production amount achieved (the yield). Hence, the lighting provided to the plants should be optimized wherever possible. In particular, a broken luminaire should normally be fixed or replaced as soon as possible. It is appreciated herein, however, that the benefit of performing such maintenance (e.g. in terms of the effect on the yield of the plants) may not actually be substantial enough to warrant addressing the maintenance immediately.

Examples described herein relate to systems, methods and computer programs for forecasting the effect on yield that a possible maintenance action of a horticulture lighting system would have if enacted, and generating an output indicative of this effect, e.g. to a user such as a grower or manager. The output generated by the method provides a more accurate prediction regarding the expected effect on yield which would be caused by the possible maintenance action being performed. This enables better informed decisions to be made concerning when maintenance of the lighting system should be performed. That is, the effect on yield is determined proactively, ahead of time. The effect is forecasted rather than simply assessed based on the current situation. When forecasting the effect on yield of a maintenance action, the inventors have recognized that also other forecasting data affecting yield can be taken into account to improve the forecasted effect.

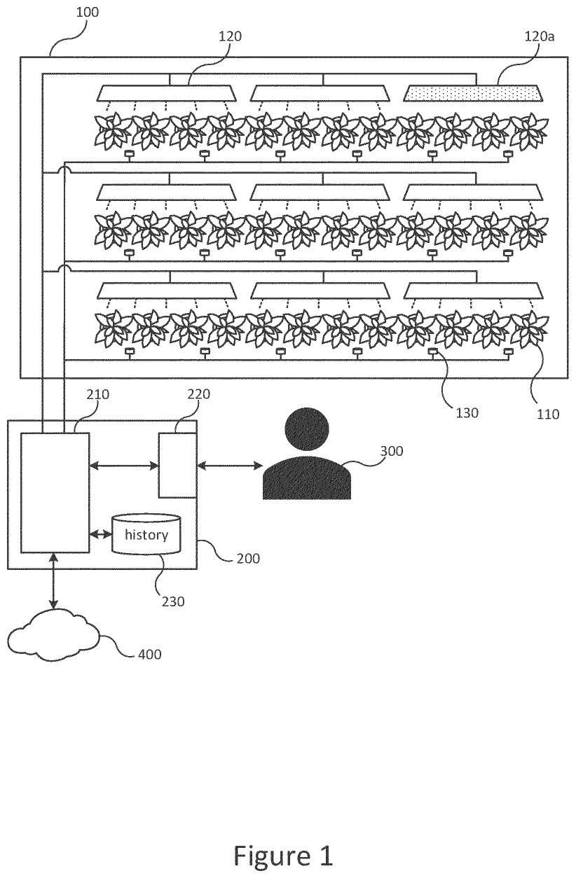

FIG. 1 shows schematically an example of an environment 100 for growing one or more plants 110. The environment 100 may be, for example, a greenhouse, a garden, a vertical farm, etc. Greenhouses are considered partially controlled environments where influences from outdoor climate/weather conditions on indoor greenhouse climate cannot be neglected. Gardens are open environment where the amount of control of the environment for the growth of plants is limited. Vertical farms are fully controlled, closed environments where influences from outdoor climate/weather conditions on the indoor climate is limited.

In this example, a horticulture lighting system and one or more sensors 130 are located in the environment 100 along with the plants 110. In some examples, the plants 110 are all the same type of plant. In other examples, the plants 110 comprise two or more types of plant. Plants may be grown for producing vegetables, fruits, flowers, etc.

The lighting system comprises one or more luminaires 120 for providing light to the plants 110. It is understood that the exact number and arrangement of luminaires can vary and that, in general, each luminaire 120 will provide light to a different one or more of the plants 110, although there may be some overlap e.g. between neighbouring luminaires 120 and neighbouring plants 110. In some examples, the luminaires 120 are all the same type of luminaire. In other examples, the lighting system may comprise two or more different types of luminaires (with for example different output light characteristics, such as different colours, light output spectrum, power output, etc).

Growth of the plants 110 is affected by a number of factors such as amount of light, water and nutrition, temperature, etc. Of these, the light available to the plants 110 has a particularly strong effect on growth. The light available may comprise both light provided to the plants 110 by the lighting system and also ambient light. Ambient light includes, for example, natural light from the sun, whether direct or through one or more windows or the like.

The one or more sensors 130 shown in FIG. 1 are optional. Examples of sensors include photosensors, temperature sensors, carbon dioxide sensors, pest sensors, etc. In some examples, the sensors 130 are all the same type of sensor. In other example, the sensors 130 comprise two or more different types of sensors. This is returned to later below.

A management system 200 is provided for horticultural management, in particular for monitoring the lighting system. The management system 200 may be part of the horticulture lighting system for the growth environment i.c. the horticulture facility, may be part of a climate system for the growth environment i.c. the horticulture facility, may be part of a horticulture growth control system for the growth environment i.c. the horticulture facility, or may be part of a service system for the growth environment i.c. the horticulture facility. Each of these systems may be partially on-site or off-site from the horticulture facility and communicate with the horticulture facility, especially the horticulture lighting system, via any known wired or wireless communication means. In examples, the management system may be hosted by the supplier of the horticulture lighting system and its functionality may be offered to the farmer as a service. That is, the methods described herein may be hosted by the supplier of the horticulture lighting system and implemented on a management system at least partially off-site from the horticulture facility, wherein at least the off-site part of the management system communicates via a wired or wireless communication means with the horticulture lighting system on-site. The off-site part of the management system may for example be operatively coupled to the on-site horticulture lighting system via a wired or wireless communication network such as the Internet.

The management system 200 comprises a controller 210, a user interface 220, and a memory 230. The controller 210 is operatively coupled to the user interface 220 and the memory 230. The controller 210 may be implemented using one or more computing devices, processors, etc. The user interface 220 may comprise one or more of a display screen, a touchscreen, a keyboard, a mouse, etc.

The lighting system and the one or more sensors 130 (when present) are operatively coupled to the management system 200 and/or the controller 210 of the management system 200. The management system 200 and/or the controller 210 of the management system 200 may also be operatively coupled to a network 400 as shown in FIG. 1. The network 400 may be or include, for example, the Internet.

A user 300 is able to receive data from and provide input to the management system 200 using the user interface 220. The user 300 may be, for example, a horticulturalist who is the manager of the environment or horticulture facility 100, a farmer, etc. In particular, the user 300 may be in charge of performing maintenance on the lighting system.

The controller 210 or even the entire management system 200 may be implemented as part of the lighting system.

At any given moment, there may be at least one possible maintenance action that the user 300 can perform on the lighting system. For the purposes of explanation, FIG. 1 shows an example in which one of the luminaires 120 is a failed luminaire 120a. That is, that luminaire 120a has broken and is no longer generating light. Alternatively, the luminaire may experience performance deterioration such as reduces light output compared to expected light output. The user 300 has the option of replacing the failed luminaire 120a. However, replacement of the luminaire 120a may not be trivial. Rather, it may involve costs both in terms of financial cost of a new luminaire and also time and effort. It is also not necessarily the case that the lack of light from the failed luminaire 120a will have any (substantive) effect on the growth of the plants 110. For example, there may be sufficient ambient light already present within the environment 100 for optimum or sufficient growth. In such cases, replacing the failed luminaire 120a may not have any beneficial effect on the crop yield.

Examples disclosed herein allow the user 300 to make a more informed decision in relation to carrying out one or more possible maintenance actions on the lighting system.

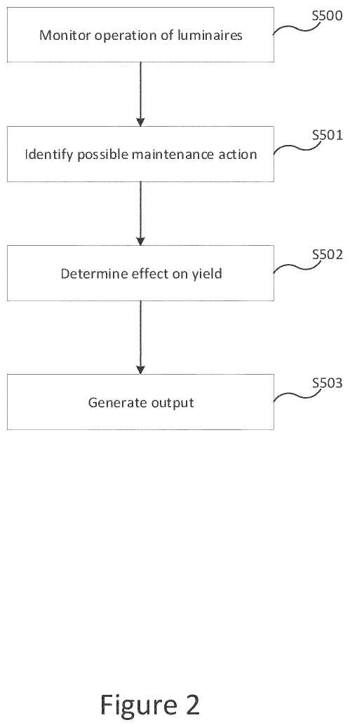

FIG. 2 shows schematically an example method performed by the controller 210.

At S500, the controller 210 monitors operation of the luminaires 120 of the lighting system. This may include extracting information regarding prior operation of the luminaires 120. For example, the controller 210 may determine an operating history (e.g. power output/usage at particular instants in time, total time on, output light level or dim level at particular instants in time, etc.) for each luminaire 120. Such information may be stored by the controller 210 in memory 230 for use in determining a failure (or potential future failure based on historical operating data) of one or more luminaires 120. In this example, the controller 210 determines that luminaire 120a has failed. The controller 210 may use a wired or wireless data or network connection with the lighting system 100 to exchange data with the lighting system 100 to monitor the operation of the luminaires 120.

At S501, the controller 210 identifies a possible maintenance action to be performed on the lighting system based on the monitoring. In this example, the controller 210 identifies, based on the determination, replacement (or at least fixing) of the failed luminaire 120a as the possible maintenance action.

At S502, the controller 210 determines an effect on yield resulting from the possible maintenance action being enacted. The controller 210 may be provided with yield forecasting software for this purpose. In an alternative arrangement, the controller 210 may access remote yield forecasting software (e.g. via the network 400).

In this example, the controller 210 determines an effect on yield that would result if the failed luminaire 120a was replaced. That is, the controller 210 predicts the change to the yield from the plants 110 which would result from the additional light that a replacement luminaire would provide.

Determining the effect on yield may comprise estimating a first yield value for a scenario in which the failed luminaire 120a is not replaced (and therefore the plants 110 do not receive light from that failed luminaire 120a) and also estimating a second yield value for a different scenario in which the failed luminaire 120a is replaced (and therefore the plants 110 receive light from the replacement luminaire). The controller 210 may then determine the effect on yield that replacement of the failed luminaire 120a would have as the difference between the second yield value and the first yield value.

At S503, the controller 210 generates an output indicative of said effect. For example, the effect on yield may be indicated to the user 300 via the user interface 220. In this example, this may comprise displaying a value (e.g. in kilograms) to the user 300 equal to the determined effect on yield which is predicted to be observed if the failed luminaire 120a were to be replaced. The user 300 is therefore able to make a more informed decision regarding replacement of the failed luminaire 120a.

In some examples, the user 300 may provide feedback to the controller 210 (e.g. via the or another user interface). The controller 210 may then re-iterate the method above based on the feedback. The feedback may be for example new values for one or more input parameter, e.g. more data, more accurate data, etc. pertaining to the weather, light, or any other environmental condition influencing the estimated yield. This is advantageous because, for example, the user can update one or more input values to take into account a particular harvesting strategy (e.g. harvest amount versus time), expectations on how the external weather will impact the internal conditions, etc. For example, the controller 210 may have generated the prediction based on weather data and a standard greenhouse optical/thermal model, but the grower knows that actually their growing environment is well insulated and that the external weather will not impact conditions in the environment so much. The grower may notice this because, for example, the prediction from the controller 210 is, from the grower's experience, clearly too high or too low.

In an example, the controller 210 may compare the determined effect on yield to a threshold yield value. If the effect exceeds the threshold, the controller 210 may send one or more signals causing the possible maintenance action to be performed automatically. For example, the controller 210 may order a replacement luminaire to be delivered, contact a maintenance individual with details of the maintenance action to be performed, etc.

Put simply, the method described above allows the controller 210 to determine an effect on yield resulting from performance of a possible maintenance action. The controller 210 may perform this method in respect of a plurality of different possible maintenance actions. For example, more than one luminaire 120 may fail. In such cases, the possible maintenance action may be replacement of some or all of those failed luminaires. The controller 210 may assess the impact of replacement of each of the failed luminaires separately by performing the method described above in relation to maintenance of each one of the failed luminaires separately and various combinations of two or more of the failed luminaires.

In order to determine the effect on yield expected to result from performance of a given possible maintenance action, the controller 210 may take into account one or more additional factors, as explained below.

In a first example, the controller 210 may receive temperature data indicative of a temperature within the environment 100.

The sensors 130 may comprise one or more temperature sensors for measuring a temperature within the environment. The controller 210 may receive temperature data from the one or more temperature sensors. Alternatively or additionally, the controller 210 may receive temperature data from an external service via the network 400. Alternatively or additionally, the temperature data may be historical temperature data stored in memory 230 which can be accessed by the controller 210. E.g. the historical temperature data may be used to forecast the (future) temperature data indicative of the temperatures which will affect plant growth in the future. Forecasted (future) temperature data indicative of the temperatures which will affect plant growth may also be retrieved or deduced from weather/climate data received from an external service via the network 400. In an example, historical temperature data may be considered together with or in relation to historical operating data of the luminaire. This may provide additional information on a desired or preferred maintenance action.

In a second example, the controller 210 may receive ambient light data indicative of ambient light within the environment 100. The sensors 130 may comprise one or more light sensors (e.g. photodetectors) for measuring a light level within the environment. The controller 210 may receive ambient light data from the one or more light sensors. Alternatively or additionally, the controller 210 may receive ambient light data from an external service via the network 400. Alternatively or additionally, the ambient light data may be historical ambient light data stored in memory 230 which can be accessed by the controller 210. E.g. the historical ambient light data may be used to forecast the (future) ambient light data indicative of the ambient light level which will affect plant growth in the future. Forecasted (future) ambient light data indicative of the ambient light level which will affect plant growth may also be retrieved or deduced from weather/climate data received from an external service via the network 400. In an example, historical ambient data may be compared to historical operating data of the luminaire. This may provide additional information on the luminaire's contribution to overall lighting for the plants and help in deciding the best maintenance action.

In a third example, the controller 210 may receive carbon dioxide data indicative of a carbon dioxide level within the environment 100. The sensors 130 may comprise one or more carbon dioxide sensors for measuring a carbon dioxide level within the environment. The controller 210 may receive carbon dioxide data from the one or more carbon dioxide sensors. Alternatively or additionally, the carbon dioxide data may be historical carbon dioxide data stored in memory 230 which can be accessed by the controller 210. In an example, historical carbon dioxide data may be compared to historical operating data of the luminaire. This may provide additional information on historical photosynthesis efficiency and growth (and thus yield) of the plants and help in deciding the best maintenance action for the best photosynthesis and yield.

In a fourth example, the controller 210 may receive pest data indicative of pests within the environment 100. The sensors 130 may comprise one or more pest sensors for detecting pests within the environment 100. The controller 210 may receive pest data from the one or more pest sensors. For example, computer vision software may be used to analyse image captured within the environment 100 to identify, e.g. pests themselves or an indication of pests such as damage to leaves, trapped insects, etc. In another example, humidity sensors, possibly in combination with temperature data and lighting data, may give an indication of pest risks.

In a fifth example, the controller 210 may receive plant age data indicative of an age of the plants 110. The plant age data may be stored in memory 230. The plant age data may be input by a user or derived from input from a user.

In the examples given above, the possible maintenance action was the replacement of the failed luminaire 120a with a working luminaire. However, this is not the only example of a possible maintenance action.

In an example, a possible maintenance action may be the replacement of a luminaire 120 having a sub-optimal light output. For example, the luminaire 120 may have degraded over time or may be an old style of luminaire (compared to a newer model). The possible maintenance action may be replacement of an old luminaire with a new luminaire or replacement of a luminaire with an improved luminaire. Examples include upgrading an old luminaire to a new luminaire which consumes less (electrical) power for the same light output, upgrading the luminaire to a luminaire with improved light spectrum for improved growth, cleaning or changing the luminaire optics, etc.

In another example, a possible maintenance action may be the replacement of a luminaire which is expected to fail, at some point in the future. This may comprise monitoring prior usage (e.g. total time on, power consumed/output, etc.) of the one or more luminaires 120 to identify an expected time of failure of a luminaire. Expected failure of a luminaire may be identified by additionally taking into account environmental data (e.g. ambient temperature, humidity, rain, etc.).

Possible maintenance actions may be identified by the controller 210 itself based on monitoring one or more aspects of the lighting system, or may be specified by the user 300.

As a first example, the controller 210 may monitor one or more aspects of prior usage of the luminaires 120, e.g., power levels, time on, output level, how “clean” is the power fed to the lighting (e.g. how stable the supply voltage is), etc. to identify failure, near failure or possible future failure of a luminaire 120.

As a second example, a possible maintenance action may be specified by the user 300 via the user interface 220, e.g. by specifying one or more of the luminaires 120 which could potentially be replaced.

If a possible maintenance action is specified, the controller 210 is able to generate an output indicating the projected effect on yield that taking such maintenance action would have. The effect may be indicated to the user 300, for example, in terms of yield itself (e.g. in kilograms, or kilograms per unit area). In other examples, as discussed in more detail below, the effect may be indicated to the user 300 in financial terms.

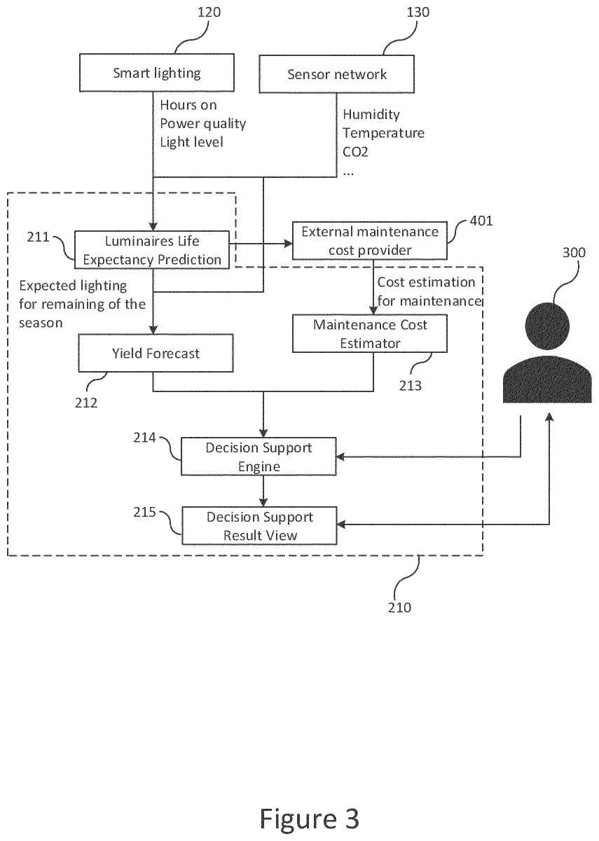

FIG. 3 shows schematically an example of the controller 210 in more detail. The controller 210 comprises a luminaire life expectancy prediction module 211, a yield forecaster 212, a maintenance cost estimator 213, a decision support engine 214 and a decision support result view module 215. These modules may be implemented as software programs adapted to run on a processor of the controller 210. Also shown is an external maintenance cost provider 401, the lighting system (one or more luminaires 120) and sensor network (one or more sensors 130) as discussed above.

The luminaire life expectancy prediction module 211 is operatively coupled to the lighting system and, in examples, the one or more sensors 130. The luminaire life expectancy module 211 is configured to identify a possible maintenance action. In operation, the luminaire life expectancy prediction module 211 monitors operation of the one or more luminaires 120 including, for example, one or more of hours on, power usage, power supply quality, and light level of each luminaire 120. In an example, the luminaire life expectancy module 211 is configured to determine expected failure of a luminaire 120 based on the monitoring. For example, each luminaire 120 may be associated with a maximum lifetime (e.g. stored in memory 230). The luminaire life expectancy prediction module 211 may estimate a failure time of a given luminaire 120 based on the accrued hours on and the maximum lifetime. In examples, the luminaire life expectancy prediction module 211 may take into account input from the sensors 130. For example, sensor input indicating harsh conditions (e.g. high temperatures) may decrease the estimated remaining lifetime of a luminaire 120.

The yield forecaster 212 is operatively coupled to the lighting system, the sensor network, and the luminaire life expectancy prediction module 211. The yield forecaster 212 may comprise yield forecasting software capable of calculating a predicted yield value for a given set of input parameters. In operation, the yield forecaster 212 determines an effect on yield resulting from performance of the possible maintenance action identified by the luminaire life expectancy prediction module 211. In examples, as discussed above, this may comprise receiving additional input data from the sensor network. The yield forecaster 212 generates an output indicative of the determined effect on yield resulting from performance of the possible maintenance action. The output may be further used by the decision support engine 214 to determine the monetary value of the effect on yield resulting from performance of the possible maintenance action.

The decision support engine 214 is operatively coupled to the yield forecaster 212 and, in examples, the maintenance cost estimator 213.

In examples, the decision support engine 214 may derive a gross monetary value from the yield value when combined with the actual or expected crop price for the plants 110. This may be the gross value of the yield. The decision support engine 214 may receive actual or expected crop price data and convert the effect on yield of the possible maintenance action (as determined using the method above) into an effect on value.

The (actual or expected) crop price data may be received by the decision support engine 214 via the network 400, e.g. from an external service.

Alternatively or additionally, historical crop price data may be stored in memory 230 which can be accessed by the decision support engine 214. In such cases, the decision support engine 214 may access the memory 210 and determine expected crop price data based on the historical crop price data (e.g. for a corresponding time in the previous financial year, or an average over several previous financial years).

Alternatively or additionally the (actual or expected) crop price data may be specified by the user 300 via the user interface 220.

The decision support engine 214 may also take into account other factors such as product demand at particular times when determining the gross monetary value of the crop yield. For example, in many countries red roses may have a higher demand on St. Valentine's day than at other times. In examples, the user 300 may specify time frames for which a higher production is desired, and time frames for which a lower production could have less impact.

The decision support result view module 215 is operatively coupled to the decision support engine 214. In operation, the decision support result view module outputs the determined effect on yield to the user 300.

In examples, the decision support engine 214 may convert the gross monetary value into a net monetary value (income) by taking into account the cost associated with the possible maintenance action. The decision support result view module 215 may then output the net monetary value, e.g. via the user interface 220 to the user 300.

In examples, this may comprise the controller 210 identifying one or more costs to be subtracted from the gross monetary value to determine the net monetary value. The “cost” may be negative (that is, the method may comprise identifying one or more benefits associated with the possible maintenance action being performed).

A first example of such a cost is a cost of performing the possible maintenance action. Workforce availability may additionally or alternatively be taken into account. This is advantageous because knowing the best time to harvest does not guarantee it will be possible to also perform the maintenance action (there may not be any workers available that day). For example, instead of paying the workforce extra to harvest during Christmas, the grower may want, for example, to harvest a little less (in terms of yield) a few days before, or a little more (in terms of yield) a few days later. The harvest day can also be tuned and optimized by changing the input parameters, particularly light/temperature/CO₂. A particular advantage to be able to predict the effect on yield arising from a possible maintenance action is that a situation can be avoided in which a lighting failure needs maintenance on a day on which the workforce is either very expensive or not available at all.

A second example of such a cost is an energy cost associated with an energy requirement which would be incurred once the possible maintenance action is performed. For example, replacing a failed luminaire with a new luminaire will mean that the amount of energy required to run the lighting system will increase. The controller 210 may subtract the cost of this increased energy usage from the gross monetary value to determine a net monetary value.

As mentioned above, the “cost” may be negative. This may be the case, for example, if the possible maintenance action is the replacement of an old luminaire with a new luminaire which can achieve the same light output level at a lower power.

In a specific example, the luminaire life expectancy prediction module 211 may be operatively coupled to an external maintenance cost provider 401, as shown in FIG. 3. In operation, the luminaire life expectancy prediction module 211 provides the determined possible maintenance action to the external maintenance cost provider 401. The external maintenance cost provider 401 returns an expected cost of performing that possible maintenance action.

The maintenance cost estimator 213 receives the expected cost of performing that possible maintenance action from the external maintenance cost provider 401. The decision support engine 214 receives the expected cost from the maintenance cost estimator and derives the net monetary value from the gross monetary value using the expected cost of the possible maintenance action. The net cost may then be displayed to the user 300 by the decision support result viewer 215.

As mentioned above, examples described herein allow for the (expected) effect on yield to be determined for different scenarios in which different maintenance actions are or are not performed. Hence, in examples in which the yield is transformed into a monetary value (either gross or net), this allows for a “scenario analysis” to evaluate the earnings of the grower based on different maintenance strategies. For example, knowing (from the life expectancy) that the lights will have a certain performance over time, and that the luminaires vendor will provide certain prices for certain maintenance orders, different scenarios can be analysed using methods going from a simple brute force algorithm to more complex machine learning strategies. For example, Reinforcement Learning may be used to learn the best strategy. A brute force approach may comprise, for example, evaluating the yield forecast for different maintenance strategies (until a certain “stop condition”, e.g. time, yield forecast itself reaching a maximum, etc.)

This sort of maintenance scenario analysis service is advantageous to improve pricing strategy by smartly allocating orders and shipments, to optimizing operations, and to improve sustainability by for example reducing transportation needs.

Further extensions could consider the latest technologies available as far as luminaires are concerned and evaluate the possibility of replacing the whole lighting installation whenever the current one is outdated and does not offer sufficient performance. That is, the possible maintenance action considered by the controller 210 may be the replacement of the entire lighting system (e.g. every luminaire 120) with a new set of luminaires.

In examples, a separate lighting system controller is provided for controlling the lighting system. The controller 210 may then instruct the lighting system controller how to control the lighting system. Alternatively, the controller 210 itself may control the lighting system. In either case, the controller 210 can determine the luminaires 120 operation in terms of on/off, dim level, colour output, etc.

The controller 210 may provide adapted light settings based on the outcome of the decision support engine 214. For example, if a maintenance action is to be postponed or brought forward because of effects on yield or harvest, the controller 210 may suggest adapted light settings to affect a postponed or brought forward harvest time. Generally, the controller 210 may analyse various possible maintenance actions and possible light settings to find a combination which minimises overall costs for the grower or maximized financial yield.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (including for example a solid-state drive or SSD).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A computer-implemented method of monitoring a horticulture lighting system that provides lighting for plants within an environment using a horticulture management system, the method implemented by a controller and comprising:
monitoring, by a luminaire life expectancy prediction module of the controller, operation of one or more luminaires of the horticulture lighting system, wherein the monitoring comprises monitoring prior usage of the one or more luminaires to identify an expected time of failure or identify a performance deterioration of a luminaire of the one or more luminaires;
identifying, by the luminaire life expectancy prediction module of the controller, a possible maintenance action to be performed on the lighting system based on the monitoring, wherein the possible maintenance action comprises replacing, fixing or upgrading a luminaire of the one or more luminaires;
determining, by a yield forecast module of the controller, an effect on yield resulting from the possible maintenance action being enacted, wherein determining the effect on yield comprises estimating a first yield value based on the possible maintenance action not being enacted, estimating a second yield value based on the possible maintenance action being enacted, and determining the effect on yield as the difference between the second yield value and the first yield value; and
generating, by the yield forecast module of the controller, an output indicative of said effect.

2. The method according to claim 1, further comprising:
deciding on enacting the possible maintenance action based on the generated output; and
adapting a light setting of the horticulture lighting system based on the decision on enacting the possible maintenance action.

3. The method according to claim 1, comprising receiving temperature data indicative of a temperature within the environment and wherein the effect on yield is determined based at least in part on the temperature data.

4. The method according to claim 1, comprising receiving ambient light data indicative of ambient light within the environment and wherein the effect on yield is determined based at least in part on the ambient light data.

5. The method according to claim 1, comprising receiving carbon dioxide data indicative of a carbon dioxide level within the environment and wherein the effect on yield is determined based at least in part on the carbon dioxide data.

6. The method according to claim 1, comprising receiving pest data indicative of pests within the environment and wherein the effect on yield is determined based at least in part on the pest data.

7. The method according to claim 1, comprising receiving plant age data indicative of an age of the plants and wherein the effect on yield is determined based at least in part on the plant age data.

8. The method according to claim 1, comprising:
receiving, by a decision support engine of the controller, crop price data; and
converting, by the decision support engine of the controller, the determined effect on yield into a gross monetary value based on the crop price data; and
outputting, by a decision support result view module of the controller, an indication of the gross monetary value.

9. The method according to claim 8, comprising:
identifying, by a maintenance cost estimator of the controller, one or more costs associated with the possible maintenance action being performed; and
determining, by the decision support engine of the controller, a net monetary value based on the gross monetary value and the one or more costs associated with the possible maintenance action being performed; and
outputting, by the decision support result view module of the controller, an indication of the net monetary value.

10. The method according to claim 9, wherein the one or more costs comprise a cost of performing the possible maintenance action.

11. The method according to claim 9, wherein the one or more costs comprise an additional energy cost or a reduction in energy cost incurred by performance of the possible maintenance action.

12. The method according to claim 1, wherein the possible maintenance action includes a preventive maintenance action on the luminaire to change operation or improve reliability or lifetime of the horticulture lighting system.

13. The method according to claim 1, further comprising
hosting the horticulture management system by a supplier of the horticulture lighting system, wherein the hosting is at least partially off-site from the environment; and
providing a wired or wireless communication between the off-site hosted part of the horticulture management system and the horticulture lighting system on-site in the environment, for monitoring operation of the one or more luminaires of the horticulture lighting system.

14. A controller for monitoring a horticulture lighting system that provides lighting for plants within an environment, the controller being configured to, in operation:
monitor, by a luminaire life expectancy prediction module of the controller, operation of one or more luminaires of the horticulture lighting system by monitoring prior usage of the one or more luminaires to identify an expected time of failure or identify a performance deterioration of a luminaire of the one or more luminaires;
identify, by the luminaire life expectancy prediction module of the controller, a possible maintenance action to be performed on the lighting system based on the monitoring, wherein the possible maintenance action comprises replacing, fixing or upgrading a luminaire of the one or more luminaires;
determine, by a yield forecast module of the controller, an effect on yield resulting from the possible maintenance action being enacted by estimating a first yield value based on the possible maintenance action not being enacted, estimating a second yield value based on the possible maintenance action being enacted, and determining the effect on yield as the difference between the second yield value and the first yield value; and
generate, by the yield forecast module of the controller, an output indicative of said effect.

15. A computer program comprising a non-transitory computer readable medium comprising instructions such that when the instructions are executed on a computing device, the computing device is arranged to monitor a horticulture lighting system that provides lighting for plants within an environment by:
monitoring, by a luminaire life expectancy prediction module of the computer program, operation of one or more luminaires of the horticulture lighting system by monitoring prior usage of the one or more luminaires to identify an expected time of failure or identify a performance deterioration of a luminaire of the one or more luminaires;
identifying, by the luminaire life expectancy prediction module of the computer program, a possible maintenance action to be performed on the lighting system based on the monitoring, wherein the possible maintenance action comprises replacing, fixing or upgrading a luminaire of the one or more luminaires;
determining, by a yield forecast module of the computer program, an effect on yield resulting from the possible maintenance action being enacted by estimating a first yield value based on the possible maintenance action not being enacted, estimating a second yield value based on the possible maintenance action being enacted, and determining the effect on yield as the difference between the second yield value and the first yield value; and
generating, by the yield forecast module of the computer program, an output indicative of said effect.
